(19) United States
(12) Patent Application Publication
(10) Pub. No.: US 2025/0100942 A1
(43) Pub. Date: Mar. 27, 2025

(54) Expandable Ready Mix Joint Compound Formulation and Method of Making Same

(71) Applicant: Panel Rey, S.A., Monterrey (MX)

(72) Inventors: Amba Ayambem, Garcia (MX); Arturo Palacios Pargas, San Nicolas de los Garza (MX); Julian Elizondo Urbina, Escobedo (MX); Carlos Romario Quezada, El Carmen (MX)

(21) Appl. No.: 18/896,225

(22) Filed: Sep. 25, 2024

Related U.S. Application Data
(60) Provisional application No. 63/585,664, filed on Sep. 27, 2023.
(60) Provisional application No. 63/595,561, filed on Nov. 2, 2023.

(51) Int. Cl. C04B 38/02; C04B 14/04; C04B 40/06; C04B 111/00

(52) U.S. Cl. CPC C04B 38/02; C04B 14/045; C04B 40/0633; C04B 2111/00681

(57) ABSTRACT

A joint compound system includes a drying type ready mix joint compound and a gas generation ingredient added to the ready mix joint compound just prior to use. In some aspects, the gas generation ingredient includes sodium percarbonate. In an aspect, the formulation includes a peroxide stabilizer. The peroxide stabilizer can include sodium silicate. The use of the gas generation ingredient and peroxide stabilizer create an extended period of gas generation, leading to an expansion of the mix joint compound during application, which reduces shrinkage after application, and eliminates the needs for multiple coatings.

### FIELD OF THE INVENTION

This invention relates to a ready mix joint compound formulation that expands as the joint compound formulation dries.

### BACKGROUND OF THE INVENTION

Conventional joint compounds are divided into two general categories; the setting type and the drying type. Setting-type joint compounds are usually powder mixes containing calcined gypsum (calcium sulfate hemi-hydrate) as a filler. This type of joint compound is typically mixed with water at the jobsite and, when applied unto a joint, sets over a period of time, often before all of the carrier water evaporates. This latter point, the fact that this kind of joint compound sets before a substantial portion of the carrier water evaporates means that shrinkage or contraction of the joint compound is minimal. Consequently, a single coat is often enough to obtain a smooth surface finish.

The drying-type joint compounds are comprised of inert fillers such as calcium carbonate and gypsum. This type of joint compound is applied unto a wallboard joint in the form of an aqueous paste whereupon the paste dries to hardness. The drying process involves the evaporation of water and a concomitant contraction of the bulk interior (of the joint compound) to occupy some of the space that has been vacated by the evaporating water. While such shrinkage is a natural process, the net result is that the cycle of joint compound application, drying, shrinkage, and re-application needs to be performed multiple times in order to achieve a desired smooth surface. Indeed, according to ASTM C840 and the Gypsum Association document GA-214, there are six “levels” of numerically designated gypsum board finishing beginning with Level 0 through Level 5. Level 0 represents a bare gypsum wallboard joint with no joint compound. Each subsequent joint compound application is designated numerically with a correspondingly higher “level”. Thus, level 5 is a joint system where five successive coats of joint compound have been applied. For most buildings though, a level 4 finish is sufficient, which means four different coats. The need to apply at least four different coats in order to finish a joint is wasteful, labor intensive, and costly. Over the years, there have been a number of approaches and attempts to reduce these number of coats, for example, by increasing the volume of solids in the joint compound through the incorporation of hydrophobically coated expanded perlite and other similar fillers. These attempts have at best eliminated one required coat.

### SUMMARY OF THE INVENTION

The ready mix joint compound formulation of the present invention addresses the need for a drying type, ready mix joint compound that expands as it dries. The ready mix joint compound formulation of the present invention comprises an additive which, when mixed into an aqueous mixture of a conventional ready mix joint compound formulation, undergoes a reaction that generates a gas as a biproduct. The gas becomes trapped within the matrix of the joint compound, and the trapped gas leads to an overall progressive volumetric expansion as more gas is generated. When the inventive joint compound formulation is applied unto a wallboard joint, the volumetric expansion counters the natural drying contraction/shrinkage. When dried, the joint compound formulation of the present invention exhibits zero shrinkage or even a net expansion, which in turn translates into fewer coats being required to attain the desired smooth surface finish. The inventive joint compound formulation thus reduces the number of coats that would be necessary to finish a wallboard joint down from the traditional 4 or 5 coats to as little as a single coat.

In connection with the inventive joint compound formulation, a conventional ready-mix joint compound formulation is mixed at the jobsite with an additive that reacts with the water in the joint compound to generate a gas such as carbon dioxide or oxygen. The evolved gas is trapped within the joint compound and, unable to escape, creates enough pressure such that the joint compound, which at that point still displays rheological plasticity, progressively expands. When dried, this expanding joint compound would have counteracted the natural drying shrinkage, resulting in zero shrinkage or even a net expansion with respect to the wallboard surface.

In an aspect, the invention is directed at a joint compound formulation comprising a drying type ready mix joint compound and a gas generation ingredient that are mixed aqueously together to form a joint compound that generates trapped gas within the joint compound, wherein the joint compound has a volumetric expansion that counters natural drying contraction. In an aspect, the gas is produced for at least thirty-five minutes after initial mixture. In another aspect, the gas-producing reaction does not begin until at least thirty seconds after initial mixing.

In an aspect, the gas generation ingredient comprises sodium percarbonate (SPC). The SPC makes up 0.2 to 2.5% of the weight of the joint compound formulation, with more preferably between 0.5 to 1.5%. In an aspect, the SPC has a particle size of at least 100 mesh, with preferably being at least 200 mesh, and more preferably being 400 mesh. In an aspect, the SPC is packaged in a water-soluble film creating a pod to be mixed with the drying type ready mix joint compound. The water soluble film is derived from the likes of polyvinyl alcohol, polyvinyl pyrrolidone, polyethylene glycol, sodium alginate, or sodium caseinate.

In an aspect, the joint compound formulation includes a peroxide stabilizer. In another aspect, the drying type ready mix joint compound contains sodium silicate in an amount from 0.1% to 8% by weight, and more preferably between 0.5% to 3.0% by weight.

In an aspect, the invention is directed towards a joint compound formulation comprising a drying type ready mix joint compound, a gas generation ingredient comprising sodium percarbonate (SPC), sodium silicate, and a peroxide stabilizer. In such instances, the composition includes percentages by weight of 0.5 to 2.0% for SPC, and between 0.5 to 3.0% for the sodium silicate. Further, the SPC has a particle size of at least 100 mesh.

Further objects, features and advantages will become apparent upon consideration of the following detailed description of the invention when taken in conjunction with the appended claims.

### BRIEF DESCRIPTION OF THE DRAWINGS

FIG. 1A, FIG. 1B, and FIG. 1C are photographs showing the progressive stages of a shrink ring test for a conventional ready mix joint compound formulation.

FIG. 2A, FIG. 2B, and FIG. 2C are side elevation schematic views showing the progressive stages of a shrink ring test for the conventional ready mix joint compound formulation.

FIG. 3A, FIG. 3B, and FIG. 3C are photographs showing the progressive stages of a shrink ring test for a ready mix joint compound system in accordance with the present invention.

FIG. 4A, FIG. 4B, and FIG. 4C are side elevation schematic views showing the progressive stages of a shrink ring test for the ready mix joint compound system in accordance with the present invention.

### DETAILED DESCRIPTION OF THE PREFERRED EMBODIMENTS

In one embodiment, the present invention includes a premixed mixture of sodium bicarbonate and citric acid added to a conventional ready-mix joint compound resulted in an immediate reaction that generates carbon dioxide gas. This rapid reaction with evolution of carbon dioxide gas was largely complete within five minutes. When the resulting joint compound containing these two premixed powders was, within 5 minutes, applied unto a wallboard joint, significant expansion was observed but the compound's surface became replete with surface imperfections such as numerous pockmarks as well as observable bubbles buried just beneath the surface. It is noteworthy that sodium bicarbonate and citric acid do not have to be premixed. One of them could be premixed in the ready-mix joint compound formulation (along with other formulation additives) while the other additive could be added later, at the jobsite just before expansion is desired. For example, the ready-mix joint compound formulation could include sodium bicarbonate as a component and in such a scenario, the citric acid co-reactant could be added by the finisher at the job site.

Yeast reacts with sugars and generates carbon dioxide gas as a biproduct. Hence, a joint compound formulation could, by design, contain a measured quantity of a sugar such as glucose and as part of the system, a sealed package of a measured quantity of yeast could be included inside the joint compound package. At the jobsite, the worker tears open the sealed package of yeast and mixes it into the joint compound whereupon the yeast reacts with the sugar to generate carbon dioxide gas.

Calcium peroxide, magnesium peroxide, potassium peroxymonsulfate, magnesium dihydroperoxide, carbamide peroxide, and calcium percarbonate all react with water to generate oxygen and can be used as an additive in an expandable joint compound system. Each of these compounds differs from the other in the rate at which they react with water and thus, the rate at which they generate oxygen, from a few seconds to several months.

CaO₂(calcium peroxide)+2H₂O→Ca(OH)₂+H₂O₂

MgO₂(magnesium peroxide)+2H₂O→Mg(OH)₂+H₂O₂

While the ability to generate a gas within the joint compound is central to this invention, the timing for when that gas is generated is important. In the joint finishing trade, most workers who mix a standard 5-gallon bucket filled with ready-mix joint compound would consume all of the bucket's contents (by applying the joint compound unto wallboard surfaces) within 30 minutes of mixing. Therefore, to be practical, any reaction which results in the expansion of the joint compound should continue to take place over a window of at least 35 minutes from the time of initial contact between the reactive additives and the joint compound. This is so that such a joint compound system, even if applied to a wallboard surface 30 minutes after the initial mixing, would have the opportunity to expand while it is on the wallboard surface. It is further desirable that the generation of gas (expansion) does not begin immediately upon the reactive additive's contact with the joint compound but is a little delayed for 30 seconds or more and starts a little after the finisher has finished initial mixing the components.

Sodium percarbonate is an adduct of sodium carbonate and hydrogen peroxide. When mixed with water, sodium percarbonate generates sodium and carbonate ions as well as hydrogen peroxide. The hydrogen peroxide then decomposes to yield water and oxygen gas.

2Na₂CO₃·3H₂O₂ [symbol] 4Na⁺+2CO²⁻₃+3H₂O₂

2H₂O₂ [symbol] 2H₂O+O₂

We have discovered that sodium percarbonate (SPC) is suitable as an additive for not just the kind of reaction that generates a gas and would therefore lead to expansion of the joint compound, but more importantly, to do that within a timeframe that is practical for workers. When sodium percarbonate was mixed into a conventional ready-mix joint compound, the mixture slowly began reacting and generating oxygen gas. This reaction continued for about 60 minutes, resulting in a progressive expansion of the joint compound. The net effect of this expansion was that, having been applied unto a wallboard joint, when this joint compound system dried, its expansion negated its natural tendency to contract/shrink, resulting in a dried surface that had zero shrinkage. Indeed, the level of shrinkage or expansion could be tuned depending on the weight percent dosage of sodium percarbonate that is mixed into the joint compound, as well as the specific characteristics of the conventional joint compound formulation. Because lightweight joint compound formulas generally display lower drying shrinkage, they would require a lower dosage of sodium percarbonate to counteract that shrinkage than regular weight joint compound formulations.

Different grades of SPC are available commercially from different suppliers. Solvay S.A. offers the following grades: FB-100, FB-400, and FB-700. These grades have, to various degrees, a water-soluble coating. The difference in the amount of protective coating affects both the particle size and the rate of dissolution. FB-100 has the least level of coating and is the smallest in particle size. FB-100 reacts the quickest when mixed with water. FB-700 has the highest level of coating as well as the largest particle size. It reacts the slowest when mixed with water. A delayed reaction in turn delays the generation of oxygen in a manner not unlike a time-release system.

The Provox™ brand of SPC is manufactured by OCI LLC. Provox is available in various grades: Provox, Provox-C, and Provox Ultra. The Provox grade is uncoated whereas the Provox-C and Provox Ultra are coated sodium percarbonate particles. In this invention, a special non-commercial grade of SPC was obtained from OCI LLC. This grade, which was uncoated, was comprised of particles that had been screened through 100-mesh sieves (largest particle size of around 149 microns). In an aspect, screening was performed to ensure that fine particles of SPC were obtained. When larger particles of SPC are mixed into ready-mix joint compound and then applied unto a wallboard surface, they leave a granular and uneven surface profile, which is unsightly. Fine particles, on the other hand, are easier to uniformly distribute into the joint compound during mixing and, because of their small size, do not leave a granular surface profile. Thus, particle sizes of −200, −325 or −400 mesh would be even more desirable. In an aspect, when SPC is used, the SPC makes up 0.2 to 2.5% of the compound by weight.

TABLE 1

| Ingredient | % Dosage |
|---|---|
| Calcium carbonate M200 PP | 45.40% |
| SE TYLOSE MHS 200000 P3 | 0.35% |
| Star Bond 515 PLUS | 0.40% |
| SNOBRITE kaolin clay | 1.00% |
| MICROSIL 200 S perlite | 6.20% |
| MINUGEL clay | 2.60% |
| MICA SG-70 | 1.80% |
| ACTICIDE LA 1206 | 0.20% |
| ADHESIN EP-1634 | 1.00% |
| SELVOL 205S | 2.00% |
| Water | 39.05% |

In an aspect, three different levels of fine-particle SPC, 0.5%, 1.0% and 1.5% (weight percents based on the quantity of the ready-mix joint compound), were mixed into separate containers of measured quantities of the formula as shown in Table 1. At predetermined post-mixing intervals of 2 minute, 30 minutes, and 60 minutes, each of the fine-SPC/joint compound mixtures were then applied to completely fill different laboratory shrinkage rings, along with a control sample of formula Table 1 that had no SPC. Upon completely drying, a net sample shrinkage of about 19.79% was recorded for the Control sample while the three samples containing 0.5%, 1.0% and 1.5% of SPC recorded various levels of expansion by visual inspection. Overall, the higher the level of SPC dosage, the higher the resulting next expansion of the joint compound into which the SPC was mixed. Thus, the sample containing 1.5% SPC had a greater volumetric expansion than the sample containing 1.0%, which in turn was more than the sample containing 0.5% SPC. Across a specific level of SPC dosage, there was a difference in the level of expansion relative to how long after mixing the coating was applied. For every level of SPC dosage, the mixed sample applied at 2 minutes after mixing expanded significantly more than the mixed sample applied after 30 minutes. The mixed sample applied after 60 minutes displayed the lowest level of expansion. In fact, while the joint compound sample containing 1.5% of SPC displayed net expansion after drying across all application times (2, 30, and 60 minutes), the sample containing 1.5% SPC displayed a net expansion at 2 and 30 minutes, but a slight net shrinkage when applied after 60 minutes. The sample containing 0.5% of SPC displayed net expansion at 2 minutes. When applied at 30 minutes and 60 minutes after mixing however, both displayed net shrinkage with the 60 minute sample displaying the highest net shrinkage. These observations implied that the SPC reaction that generates oxygen takes place rapidly at first but then slowly loses dies off with time.

In a commercial jobsite, it is undesirable to have dried joints that are undulating (that is, joints that are high or low, expanded or shrunken depending on when our expanding joint compound mixture was applied). In an aspect, the addition of a peroxide stabilizer to the joint compound formula helps to stabilize the reactivity of SPC within the joint compound. This stabilization results in a more uniform expansion over time, irrespective of how long after mixing the SPC/joint compound mixture was applied. Examples of such stabilizers include citric acid, boric acid, sodium triphosphate, potassium stannate, sodium stannate, tin sulfate, tin dichloride, tin tetrachloride, sodium citrate, sodium malonate, and sodium phytate.

In an aspect, to achieve desired uniform expansion over the 60 minute target application timeframe, the use of sodium silicate produced good results, as disclosed below in more detail. Sodium silicate is produced by melting silica sand with sodium carbonate at high temperature. The relative starting molar ratio of silicon dioxide to sodium carbonate characterizes the grade of sodium silicate. The silicon dioxide/sodium carbonate ratio can vary from about 1.0 to around 4.0. One manufacturer of sodium silicate is Silcomer S.A. de C.V., a supplier of sodium silicates Pentasil Malla 20 (molar ratio 1.0), S-1.6 (molar ratio 1.6), M-50 (molar ratio 2.40), C-42 (molar ratio 2.90), and S-42 (molar ratio 3.30). In some aspects, the addition of sodium silicate to the compound formula can extend the expansion up to four hours.

When Silcomer's S-42 (sodium silicate 3.3) was included in a ready-mix joint compound formulation at a percentage of 0.50% (based on the total weight of the formulation) and that formulation was mixed with SPC, a surprisingly improved stabilization and uniformity of expansion through 60 minutes was observed. Table 2 below shows a joint compound formulation of the present invention using calcium carbonate. In an aspect, the calcium carbonate was sourced from Imerys Company (Sylacauga, Alabama). This formulation incorporates S-42 (sodium silicate) at a dosage of 1%. When mixed with SPC at an SPC dosage of 1%, there was uniformity of expansion over a window of at least 60 minutes, irrespective of what time during the course of those 60 minutes the mixture was applied into the rings. The mixture in each shrinkage ring (applied at 2, 30, and 60 minutes) was identically and uniformly expanded unlike in the situation where the same joint compound did not contain sodium silicate.

TABLE 2

| Ingredient | % Dosage | Range |
|---|---|---|
| Calcium carbonate, Imerys MW100 | 58.80% | 40-70% |
| TecPoly LH70MR, cellulose ether | 0.6% | 0.3-0.7% |
| Papigel 515, starch | 0.50% | 0.0%-0.6% |
| SG 70 mica | 4.10% | 0.0%-10.0% |
| Minu Gel FG, attapulgite clay | 0.80% | 0.0%-0.6% |
| S-42, Sodium silicate | 1.0% | 0.1%-8% |
| ACTICIDE LA 1206 | 0.20% | 0.1%-0.3% |
| ADHESIN EP-1634, latex emulsion | 1.60% | 0.5%-2.0% |
| Water | 32.4% | 25%-50% |

In this invention, it is envisioned that measured quantities of sodium percarbonate would be pre-packaged and included in the box or bucket of ready-mix joint compound and protected in such a way as to avoid contact and thus premature reaction with the water in the ready-mix joint compound. The measured quantity of SPC could be packaged in candy-wrap foil whereby it can be torn opened and its contents mixed into the joint compound by the finisher at the jobsite. The measured quantity of SPC could also be packaged in a water-soluble film which would thus create a pod which the finisher could simply drop into the joint compound before mixing at the jobsite. The water-soluble film would quickly dissolve and result in the release of the SPC powder for mixing into the joint compound. One such water-soluble film that could be used to package SPC and create a pod is M7030 which is based on polyvinyl alcohol chemistry and is manufactured by Monosol Kuraray. In other aspects, the film can be derived from polyvinyl pyrrolidone, polyethylene glycol, sodium alginate, or sodium caseinate.

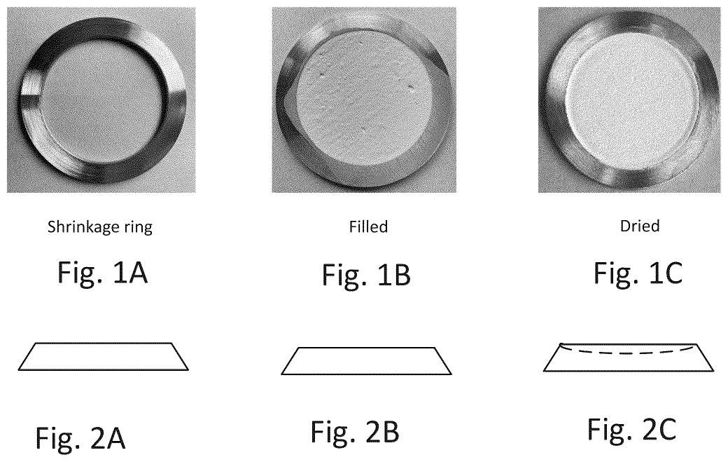

FIGS. 1A-2C show the results of a shrinkage ring test for a conventional ready mix joint compound formulation such as that described above in Table 1. FIGS. 1A and 2A show an empty standard shrinkage ring. FIGS. 1B and 2B show the standard shrinkage ring filled with the conventional ready mix joint compound formula and finished even with the top of the shrinkage ring. FIGS. 1C and 2C show the standard shrinkage ring filled with the conventional ready mix joint compound formula after the ready mix joint compound formula has dried. Note the dashed line in FIG. 2C indicating qualitatively the shrinkage of the conventional ready mix joint compound formulation.

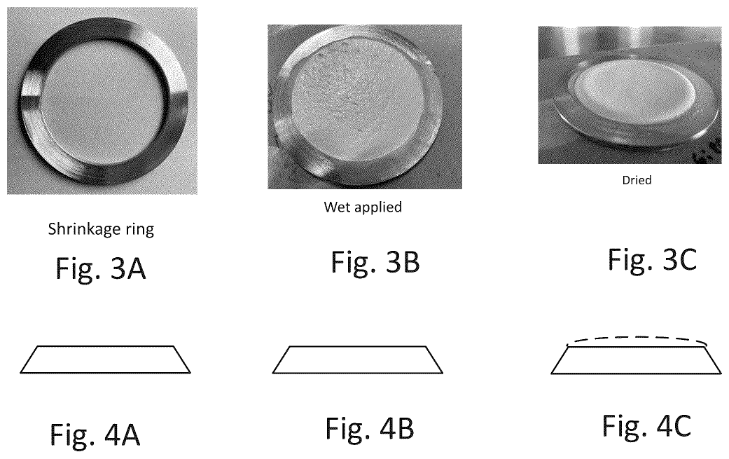

FIGS. 3A-4C show the results of a shrinkage ring test for the inventive ready mix joint compound formulation. FIGS. 3A and 4A show an empty standard shrinkage ring. FIGS. 3B and 4B show the standard shrinkage ring filled with the inventive ready mix joint compound formula and finished even with the top of the shrinkage ring. FIGS. 3C and 4C show the standard shrinkage ring filled with the inventive ready mix joint compound formula after the inventive ready mix joint compound formula has dried. Note the dashed line in FIG. 4C indicating qualitatively the expansion of the inventive ready mix joint compound formulation.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

It should be emphasized that the above-described aspects are merely possible examples of implementations, merely set forth for a clear understanding of the principles of the present disclosure. Many variations and modifications can be made to the above described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A joint compound formulation comprising:
a. a drying type ready mix joint compound; and
b. a gas generation ingredient.

2. The joint compound formulation of claim 1, wherein the joint compound and the gas generation ingredient are mixed aqueously together to form a joint compound that generates trapped gas within the joint compound, wherein the joint compound has a volumetric expansion that counters natural drying contraction.

3. The joint compound formulation of claim 2, wherein the gas is produced for at least thirty-five minutes after initial mixture.

4. The joint compound formulation of claim 2, wherein the gas-producing reaction does not begin until at least thirty seconds after initial mixing.

5. The joint compound formulation of claim 1, wherein the gas generation ingredient comprises sodium percarbonate (SPC).

6. The joint compound formulation of claim 5, wherein the SPC makes up 0.2 to 2.5% of the joint compound formulation by weight.

7. The joint compound formulation of claim 6, wherein the SPC makes up 0.2 to 1.5% of the joint compound formulation by weight.

8. The joint compound formulation of claim 5, wherein the SPC has a particle size of at least 100 mesh.

9. The joint compound formulation of claim 8, wherein the particle size is at least 200 mesh.

10. The joint compound formation of claim 5, wherein the SPC is packaged in a water-soluble film creating a pod to be mixed with the drying type ready mix joint compound.

11. The joint compound formation of claim 10, wherein the water soluble film is derived from the likes of polyvinyl alcohol, polyvinyl pyrrolidone, polyethylene glycol, sodium alginate, or sodium caseinate.

12. The joint compound formulation of claim 5, wherein the SPC is packaged in non-water soluble package prior to mixing, the non-water soluble packaging including paper or candy-wrap.

13. The joint compound formulation of claim 1, further comprising a peroxide stabilizer.

14. The joint compound formulation of claim 13, wherein the peroxide stabilizer comprises sodium silicate.

15. The joint compound formulation of claim 14, wherein the sodium silicate ranges between 0.1% to 8% by weight of the joint compound formulation.

16. The joint compound formulation of claim 15, wherein the sodium silicate ranges between 0.5% to 3.0%.

17. A joint compound formulation comprising:
a. a drying type ready mix joint compound;
b. a gas generation ingredient comprising sodium percarbonate (SPC); and
c. a peroxide stabilizer comprising sodium silicate.

18. The joint compound formulation of claim 17, wherein, by weight, the SPC ranges between 0.5 to 2.5%, the sodium silicate ranges between 0.5 to 3.0%, and wherein the SPC has a particle size of at least 100 mesh.
